(19) United States
(12) Patent Application Publication
(10) Pub. No.: US 2015/0118591 A1
(43) Pub. Date: Apr. 30, 2015

(54) FUEL CELL STACK ASSEMBLY

(71) Applicant: Intelligent Energy Limited, Loughborough (GB)

(72) Inventor: Peter David Hood, Loughborough (GB)

(73) Assignee: Intelligent Energy Limited

(21) Appl. No.: 14/397,791

(22) PCT Filed: Apr. 25, 2013
(86) PCT No.: PCT/GB2013/051046

§ 371 Date: Oct. 29, 2014

(30) Foreign Application Priority Data
May 1, 2012 (GB) 1207551.1

(51) Int. Cl. H01M 8/24; H01M 8/04

(52) U.S. Cl. CPC H01M 8/248; H01M 8/04104; H01M 8/04291; H01M 8/04007; H01M 8/2485
USPC 429/434; 429/470; 429/454; 429/450

(57) ABSTRACT

A fuel cell stack assembly comprises a plurality of fuel cells in a stack, the stack defining two opposing parallel end faces. An end plate assembly is provided at each opposing end face of the stack. The end plate assemblies are coupled together to thereby maintain the fuel cells in the stack under compression. At least one of the end plate assemblies comprises: a master plate defining a master compression face having a first portion and a second portion; a first slave plate defining a first slave compression face; and a second slave plate defining a second slave compression face. The first slave compression face faces the first portion of the master compression face and when assembled, is in compressive relationship therewith, and the second slave compression face faces the second portion of the master compression face and when assembled, is also in compressive relationship therewith.

This patent application claims priority to International Patent Application PCT/GB2013/051046, filed Apr. 25, 2013, and United Kingdom Patent Application GB1207551.1, filed May 1, 2014, the contents of which are incorporated by this reference as if fully set forth herein in their entirety.

The present invention relates to methods and apparatus suitable for assembling an electrochemical fuel cell stack.

Fuel cell stacks comprise a series of individual fuel cells built up layer by layer into a stack arrangement. Each cell itself may include various layered components such as a polymer electrolyte membrane, gas diffusion layers, fluid flow plates and various sealing gaskets for maintaining fluid tightness and providing fluid fuel and oxidant distribution to the active surfaces of the membrane. At each end face of the stack, a pair of pressure end plates coupled together by tie bars is conventionally used to hold the stack together and maintain compression on the cells in the stack.

It is most important that pressure applied by the end plates to the ends of the fuel cell stack is sufficiently uniform across the surfaces of the stack that all of the individual components of the stack are maintained in proper compressive relationship with one another. Sealing gaskets in particular must be maintained in proper compression across the entire area of each fuel cell to ensure that fluid flow paths are properly defined so that fuel and/or oxidant are correctly conveyed to the active surfaces of each cell and do not leak.

Conventionally, uniform pressure is maintained by providing substantial and robust end plates capable of maintaining sufficient excess pressure across the entire surfaces of the ends of the stack. This results in large and heavy end plates to ensure that they are sufficiently robust that they will not significantly distort under the requisite pressures and will not apply compression forces unevenly. Use of large and heavy end plates results in heavier and larger fuel cell stacks than is desirable. An alternative approach is to use lighter weight end plates but provide an additional mechanism for mitigating the effects of end plate structure distortion when compressive forces are applied. This could be a shim positioned centrally between an end plate and a first inner stack component.

One approach described in US 2006/0194094 uses an end plate having a pressure shield which is curved convexly towards the stack and a bearing plate which acts as a transition element to transmit compressive forces to a planar element of the fuel cell stack. This document can be said to recognise the importance of maintaining a uniform pressure distribution.

A problem exists as to how to maintain a uniform compressive relationship through the fuel cell stack while also allowing fluid distribution to the fuel cells in the stack. Further, minimising the size and weight of the end plates, as noted above, is desirable for incorporation of smaller fuel cell stacks for certain applications.

It is an object of the present invention to provide an improved way of ensuring good pressure distribution across the end faces of a fuel cell stack while providing flexibility in supplying the required fluids to the fuel cells.

According to one aspect, the present invention provides a fuel cell stack assembly comprising: a plurality of fuel cells in a stack, the stack defining two opposing parallel end faces; an end plate assembly at each opposing end face of the stack, the end plate assemblies being coupled together to thereby maintain the fuel cells in the stack under compression; wherein at least one of the end plate assemblies comprises:
a master plate defining a master compression face having a first portion and a second portion;
a first slave plate defining a first slave compression face;
a second slave plate defining a second slave compression face,
the first slave compression face facing the first portion of the master compression face and when assembled, being in compressive relationship therewith,
the second slave compression face facing the second portion of the master compression face and when assembled, being in compressive relationship therewith.

At least one of the slave plates may extend laterally from the master plate on at least one side defining a lateral extension portion, the lateral extension portion comprising at least one fluid distribution port communicating with a fluid distribution gallery passing through or alongside the plurality of fuel cells in the stack.

Both the first and second slave plates may extend laterally from the master plate on at least one side, each of the first and second slave plates thereby defining a lateral extension portion, and each lateral extension portion comprising at least one fluid distribution port communicating with a fluid distribution gallery passing through or alongside the plurality of fuel cells in the stack.

The at least one fluid distribution port may include at least one of a fuel distribution port, a water distribution port, an oxidant distribution port and a coolant fluid distribution port. The first and second slave plates respectively may include a different configuration of fluid distribution port. The first slave plate may define at least one of a fuel distribution port and a water distribution port, as the at least one fluid distribution port and the second slave plate may define at least one of an oxidant distribution port and a coolant fluid distribution port, as the at least one fluid distribution port.

The first and second portions of the master compression face may be at a first angle relative to one another and the first and second slave compression faces may be at a second angle to one another. The first angle may be reflex and the second angle may be obtuse, or the first angle may be obtuse and the second angle may be reflex.

The first angle and the second angle may be selected such that the first portion and second portion of the master compression face and respectively the first and second slave compression faces are non-parallel prior to application of a load to the end plate assemblies whereas, under the application of the load to maintain the fuel cells under compression, a bending moment in the master plate may cause the first portion of the master compression face and the first slave compression face to come into parallel relationship with one another by distortion of the master plate, and cause the second portion of the master compression face and the second slave compression face to come into parallel relationship with one another by distortion of the master plate.

The first angle may be greater than 180 degrees such that master compression face defines a convex surface. The convex surface may be configured such that under the application of the load to maintain the fuel cells under compression, the bending moment in the master plate causes the first portion of the master compression face and the first slave compression face to come into parallel relationship with one another by distortion of the master plate, and the second portion of the master compression face and the second slave compression face to come into parallel relationship with one another by distortion of the master plate.

The second angle may be greater than 180 degrees such that the first and second slave compression faces together define a convex surface. The convex surface may be configured such that under the application of the load to maintain the fuel cells under compression, the bending moment in the master plate causes the first portion of the master compression face and the first slave compression face, and the second portion of the master compression face and the second slave compression face, to come into parallel relationship with one another by distortion of the master plate.

The first and second portions of the master compression face may both form part of a continuous convex surface and the first and second slave compression faces may be contiguous so as to form a concave surface by abutting the first and second slave plates against one another along one edge.

The master plate may be formed from metallic material. The slave plates may be formed from non-metal material.

Both of the end plate assemblies may comprise a master plate and a first and a second slave plate.

A plurality of tie bars may be arranged to pass through the lateral extension portions of the first and second slave plates at opposing ends of the fuel cell stack. The tie bars may be configured to couple the end plate assemblies together to thereby maintain the fuel cells in the stack under compression. The plurality of tie bars may be located inwards of the at least one fluid distribution port proximal the plurality of fuel cells in order to maintain the fuel cell stack under compression.

According to another aspect, the present invention provides a method of forming a fuel cell stack assembly comprising: forming a plurality of fuel cells in a stack, the stack defining two opposing parallel end faces; positioning first and second slave plates of an end plate assembly at one end face of the stack, the first and second slave plates each having respective first and second slave compression faces facing outwardly from the stack; positioning a master plate defining a master compression face at the end face of the stack such that the master compression face is proximal the first and second slave compression faces; positioning a second end plate assembly at the opposing end face of the stack; and coupling the end plate assemblies together to bring the first and second slave compression faces into compressive relationship with the master compression face and to maintain the stack under compression.

Embodiments of the present invention will now be described by way of example and with reference to the accompanying drawings in which:

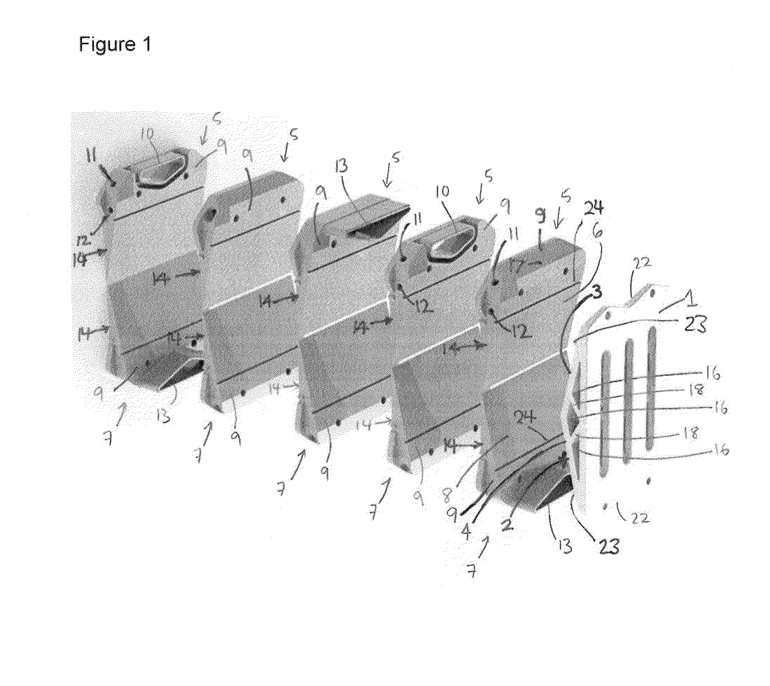

FIG. 1 shows a perspective exploded view of a master plate and five exemplary pairs of first and second slave plates, each pair having different fluid distribution ports;

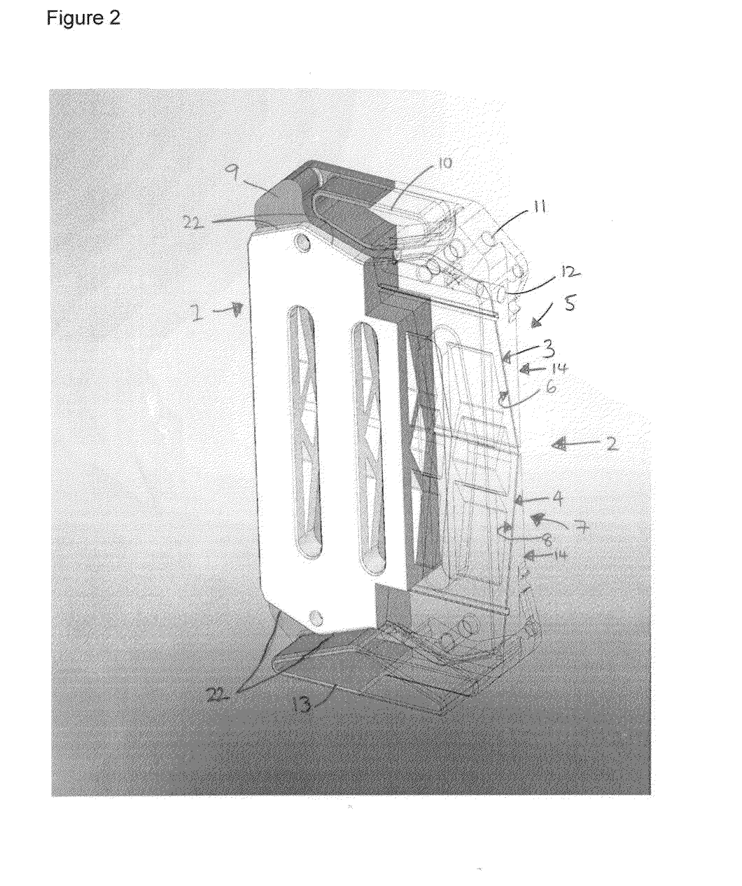

FIG. 2 shows a perspective sectional view of a master plate and first and second slave plates showing relative positions of the three elements in an assembled fuel cell stack;

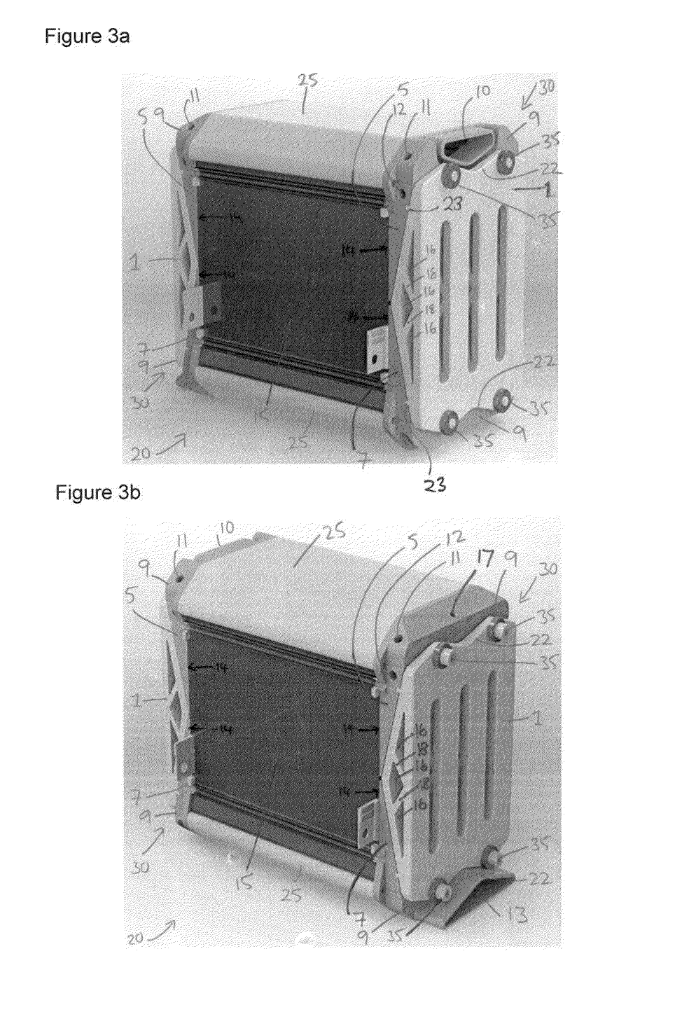

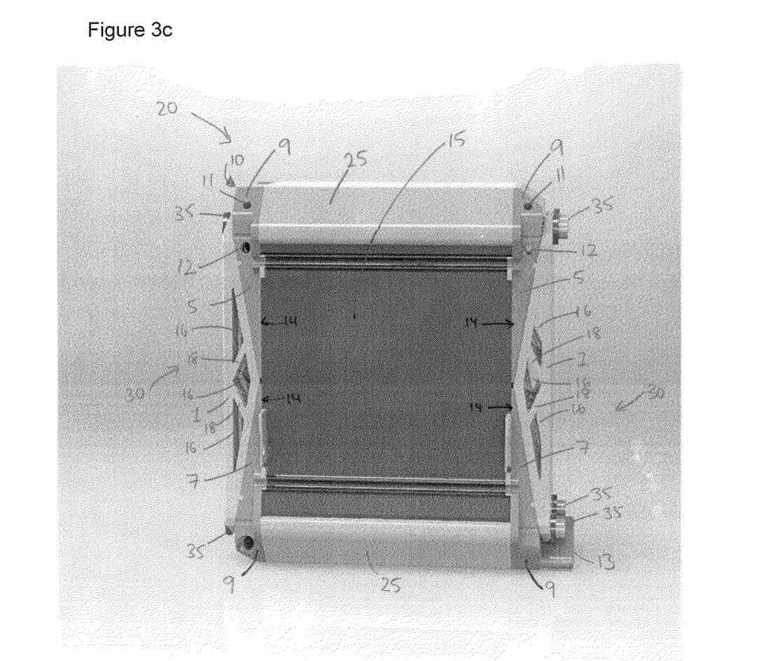

FIG. 3a shows a front perspective view of an exemplary fuel cell stack assembly;

FIG. 3b shows a rear perspective view of the fuel cell stack assembly of FIG. 3a;

FIG. 3c shows a rear view of the fuel cell stack assembly of FIGS. 3a and 3b;

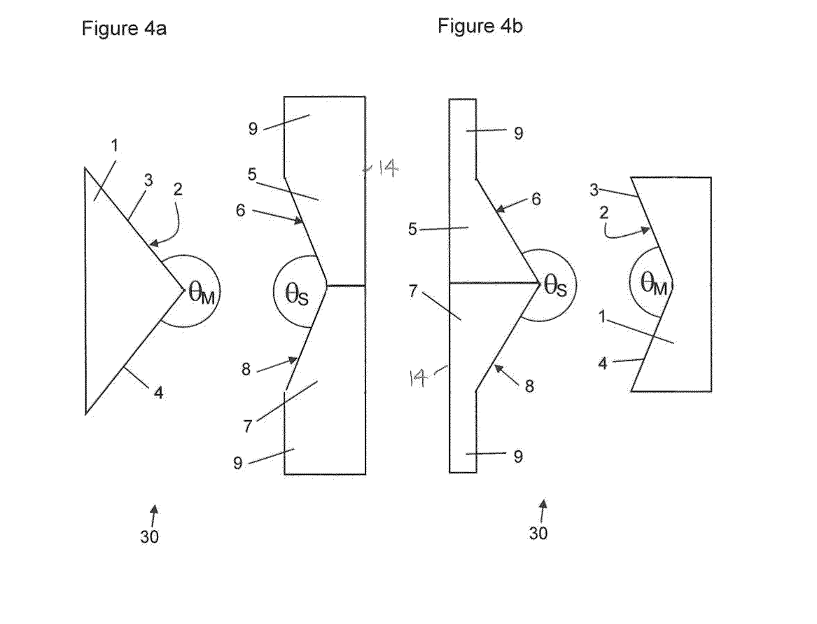

FIG. 4a shows a schematic cross-sectional view of a master plate with a convex master compression face and reflex first angle θ_{M}, and first and second slave plates with an obtuse angle θ_{S} between the first and second slave compression faces; and

FIG. 4b shows a schematic cross-sectional view of a master plate with a concave master compression face and obtuse first angle θ_{M}, and first and second slave plates with a reflex angle θ_{S} between the first and second slave compression faces; and

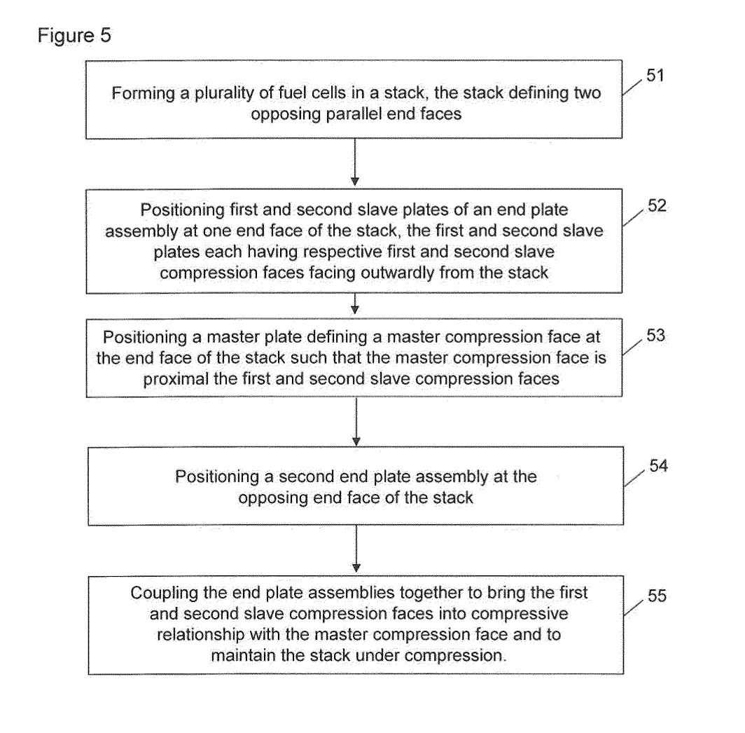

FIG. 5 shows a flow diagram of a method suitable for forming a fuel cell stack assembly.

Fundamental to a fuel cell stack assembly is the parallel relationship of the monopolar/bipolar fuel cell plates to one another. Uniform contact forces maintained across the electrodes contribute towards optimum electrode performance. The end plate (which may be an end plate assembly) is an important component governing the parallel relationship in the stack assembly, but the end plate itself will likely go through a physical distortion once a load is applied to the end plate in order to maintain the fuel cell stack under compression and bring the fuel cells into compressive relationship. Preferably, any distortion of the end plate should not be transmitted to the electrode plates of the fuel cells.

Another function of the end plate is to allow the transmission of fluids to the electrode plates of the stack. Preferably these fluids should be isolated from metallic surfaces, for example to avoid corrosion or reaction with the metallic component which may require replacement of the affected component.

Dependent on the requirements of the fuel cell stack assembly, and how the fuel cell stack assembly is to be integrated into a particular system, there are often bespoke and/or specific requirements for the end plate components. Such requirements may include particular fluid distribution port arrangements, provision for the coupling of the end plates to the fuel cell stack (for example, via the use of tie bars, clips, or bands for maintaining the stack under compression), and preferred properties of the fuel cell stack assembly (for example, making the stack as light, or as small, as possible).

FIG. 1 illustrates an exemplary master plate 1 and five exemplary pairs of a first slave plate 5 and a second slave plate 7. The first slave plate 5 and the second slave plate 7 are discrete (i.e. physically separate) elements. A master plate 1 and a pair of first and second slave plates 5, 7 together comprise an end plate assembly 30. The master plate 1 defines a master compression surface 2 which, in this embodiment comprises a first portion 3 and a second portion 4. The first slave plate 5 comprises a first slave compression face 6 and the second slave plate 7 comprises a second slave compression face 8. An end plate assembly comprising a master plate 1 and first and second slave plates 5, 7 may be located at one end, or at both ends, of the fuel cell stack depending on the particular requirements.

Each slave plate 5, 7 includes a planar back surface 14 configured for engagement with an end face of a stack of fuel cells. The planar back surface 14 may be uniformly flat or may comprise a series of pressure elements which together define a series of coplanar pressure surfaces distributed across the area of the plate which collectively define the planar back surface 14.

When assembled together to form an end plate assembly 30 as in FIG. 3a for example, the first slave compression face 6 faces the first portion 3 of the master compression face 2 and the second slave compression face 8 faces the second portion 4 of the master compression face 2. When the fuel cell stack is assembled, the first slave compression face 6 and first portion 3 of the master compression face 2 are in compressive relationship. Similarly, the second slave compression face 8 and the second portion 4 of the master compression face 2 are in compressive relationship. FIG. 2 illustrates the master plate 1 and first and second slave plates 5, 7 assembled to form an end plate assembly 30.

As best seen in FIG. 3a, both first and second slave plates 5, 7 extend laterally from or beyond the edges 22 of the master plate 1 on both sides of the master plate 1 in FIG. 1, where all the illustrated slave plates 5, 7 have a lateral extension portion 9 extending to the top of the first slave plates 5 and to the bottom of the second slave plates 7, beyond the boundary edges 22 of the master plate 1. In other examples, depending on the chosen assembly of slave plates, only one slave plate might extend laterally beyond the edges 22 of the master plate 1, on at least one side.

Lateral extension portions 9 can be seen in FIG. 1 to comprise at least one fluid distribution port 10, 11, 12, 13, 17. Such fluid distribution ports 10, 11, 12, 13, 17 can each communicate with a fluid distribution gallery passing through or down the sides of the plurality of fuel cells in the stack. Fluid distribution galleries are required for delivery of fuel and/or oxidant and/or water to the cells in the stack in a known manner. The lateral extension portions 9 may also comprise further features, such as ports, recesses, grooves or channels, for example for the attachment of an air box 25 to the fuel cell assembly 20.

The master plate 1 may be formed as an open cell structure with voids 16 and connecting limbs 18 for a lighter weight construction for any given strength. It is not required to locate any fluid distribution port apertures 10, 11, 12, 13, 17 in the master plate 1. Such apertures 10, 11, 12, 13, 17 can be located in the lateral extension portions 9 of the slave plates 5, 7.

As well as including fluid distribution ports, the first and second slave plates 5, 7 include a number of apertures for the passage of tie bars 35 (the ends of which can be seen in FIGS. 3a-3c) for assembling the stack and for maintaining the stack in compression.

The fluid distributions ports 10, 11, 12, 13, 17 can include one or more of any or all of fuel distribution ports, water distribution ports, oxidant distribution ports and coolant fluid distribution ports. For example, as shown in FIGS. 1, 2 and 3a-3c, ports for the inflow and outflow of air 10, 13 are included in the slave plates 5, 7, which may provide for the cooling of, and/or supply of oxidant (e.g. air) to, the fuel cells. Also shown are fluid distribution ports 11, 12 for the supply and distribution of fuel (e.g. hydrogen). Fluid distribution ports 11, 12 could be drillings to provide different positional options for coupling pipe connectors to the same distribution gallery, e.g. to supply the anode plates in the stack with fuel. Also shown is a water distribution port 17 for the supply and distribution of water to the fuel cells in the stack. The water distribution port 17 could be for the purpose of direct cooling by injection into the anodes or cathodes of the fuel cells or for a separate cooling circuit between fuel cell anode/cathode plates. Other possible arrangements of different ports in the lateral extension portions may also be envisaged. Some fluid distribution ports (e.g. that indicated by reference numeral 12) may be wholly or partly contained within a portion of the respective slave plate that lies within the footprint defined by the master plate, rather than being wholly contained in the lateral extension portion 9.

An advantage to the use of first and second slave plates 5, 7 is the flexibility of possible arrangements for making up the end plate assembly. As illustrated in FIG. 1, a first slave plate 5 and a second slave plate 7 used together may have different fluid distribution ports. Therefore it is possible to choose the required porting arrangements for each side of the fuel cell stack by choosing individual first and second slave plates 5, 7 with different porting arrangements.

For example, it may be required to allow cooling gas/oxidant to flow into and out of diagonally opposite edges of the fuel cell assembly. Therefore, particular coolant fluid (air flow) port requirements are needed at those two opposite edges. As another example, a first slave plate pair (that is, on one end of the fuel cell stack) may be required to define a fuel distribution port and/or a water distribution port, and a second slave plate pair (on the other end of the fuel cell stack) may be required to define an oxidant distribution port and/or a coolant fluid distribution port.

The modular adaptability of the end plate assembly achieved by having two slave plates 5, 7 allows for greater flexibility in selecting the porting arrangements of a fuel cell stack assembly. Having the option of arranging different configurations of the fuel cell stack using two slave plates with possibly different fluid distribution port arrangements means that fuel cell stacks can be assembled with increased adaptability, for example to match a particular system layout, without the need for custom components to be included.

Such modularity of the slave plates 5, 7 also provides for lower levels of end plate stock required to be held by a manufacturer/assembler to achieve a particular porting arrangement, and reduce component costs, inventory costs, and procurement costs while improving build response and delivery lead times.

Various configurations of first and second slave plates 5, 7 containing fluid ports 10, 11, 12, 13, 17 in different positions and/or different proportions may be provided to suit a particular stack. The first and second slave plates 5, 7 may however have the same first and second slave compression faces 6, 8 designed to mate with the master compression face 2. The slave plates can be manufactured by moulding.

FIGS. 3a-3c show three views of an exemplary fuel cell stack assembly 20 including a master plate 1 and first and second slave plates 5, 7 at both ends of the plurality of fuel cells 15. Tie bars 35 (the ends of which are visible in the figures) are included in the fuel cell stack assembly, and each stack has two air boxes 25 included. The exemplary fuel cell stack assembly 20 in FIGS. 3a-3c has an asymmetric cathode delivery to exhaust, e.g. where cathode air enters port 10 at the top right as viewed in FIG. 3a and exits a corresponding port at bottom left of FIG. 3a.

As shown in FIGS. 3a-3c, a fuel cell stack assembly 30 comprises a plurality of fuel cells 15 in a stack, the stack defining two opposing parallel end faces. The individual fuel cells are not shown separately. The stack has each cell parallel to the planar back surfaces 14 of the first and second slave plates 5, 7. The planar back surfaces 14 of the slave plates 5, 7 are the surfaces on the opposite sides of the slave plates 5, 7 to the slave compression faces 6, 8. The stack of cells therefore defines two opposing parallel end faces each of which engages with a respective pair of first and second slave plates 5, 7.

An end plate assembly 30, for example as described above, may be located at each opposing end face of the fuel cell stack as shown. In the example of FIGS. 3a-3c, the three-piece end plate assembly 30 is used at both ends of the fuel cell stack. However, it will be appreciated that such a three-piece end plate assembly 30 could be used only at one end of a fuel cell stack, with the other end having a conventional end plate. The end plate assemblies may be coupled together to maintain the fuel cells in the stack under compression. The coupling may be achieved using any suitable method, for example, via the use of clips, bands, or tie bars/tie rods. A plurality of tie bars may be arranged as shown in FIGS. 3a-3c to pass through the master plate 1 and first and second slave plates 5, 7, at opposing ends of the fuel cell stack. The tie bars 35 can be configured to couple the end plate assemblies 30 together to thereby maintain the fuel cells in the stack under compression.

Stack fixing points, such as the ports for locating tie bars 35 in the fuel cell stack assembly 20, are located along axes along the top and bottom edges of the master plate (as viewed in FIGS. 3a-3c) thereby substantially containing distortion of the master plate 1 under compression to distortion about an axis parallel thereto.

The plurality of tie bars 35 as shown in FIGS. 3a-3c are preferably located inwards of the fluid distribution ports 10, 11, 12, 13, 17 proximal the plurality of fuel cells 15 in order to maintain the fuel cell stack under compression. Locating the tie bars in this way closer to the fuel cells in the stack concentrates the compression of the slave plates 5, 7 onto the body of the fuel cell stack where it is most required, rather than onto the air boxes 25 via the lateral extension portions 9.

It may be that around 95% of the applied force to the plate/electrode assembly 20, applied due to compression of the fuel cell stack, is required for the (more central) electrode region, and outside of this centralised area only 5% of the total applied force is required (typically in the manifold regions where fluid distribution ports 10, 11, 12, 13 may be located). Such pressure distribution may be the optimal distribution to cause desirable uniform pressure loading across the fuel cells in the stack.

By avoiding significantly extending the master plate 1 beyond the footprint of the fuel cell plates 15, as shown in FIGS. 3a-3c, it is possible to reduce the bending moment applied to the master plate 1 because the overall height of the end plate 1 is reduced or minimised. Correspondingly if the height of the master plate is reduced or minimised, then the thickness of the master plate may also be reduced or minimised. The lateral extension portions 9 of the slave plates 5, 7 can be configured for the transmission of around 5% of the compressive force required to the outer manifold regions.

In the above examples, the end plate assemblies may have the master plate formed from metal (for example, for strength, durability and/or ease of manufacture) and the slave plates may be formed from a non-metal material, such as a plastic or toughened glass materials, e.g. for passivity.

FIGS. 4a and 4b illustrate schematic cross sectional views of two possible profiles for the master plate 1 and first and second slave plates 5, 7. The first portion 3 and the second portion 4 of the master compression face 2 are at a first angle θ_{M} relative to one another; the first slave compression face 6 and second slave compression face 8 are at a second angle θ_{S} to one another.

Introducing a reflex angle θ_{M} to the master plate 1 strengthens the master plate 1 in a critical area (along the centre angled region of the master plate 1). Such an arrangement as shown in FIG. 4a, for example, also allows for a larger mass of slave plate 5, 7 material at the outer edges of the end plate assembly 30.

With the lateral extension portions 9 of the first and second slave plates 5, 7 as shown in FIGS. 4a and 4b, a larger mass of non-metal or plastic material can be dedicated to providing fluid distribution ports in the slave plates 5, 7. Having non-metallic fluid distribution ports in the slave plates 5, 7 allows fluids supplied to the fuel cell assembly to be isolated from metallic surfaces in the end plate assembly 30. This can reduce corrosion which might otherwise occur in end plate assembly parts made from corrodible metal that are exposed to fluid flows. This also limits or avoids the use of expensive corrosion resistant metal (e.g. stainless steel) in the end plate assembly.

The first angle θ_{M} on the master plate 1 and the second angle θ_{S} formed by the first and second slave plates 5, 7, are preferably selected so that when the master plate undergoes distortion under compression, the second angle θ_{S} plus the first angle θ_{M} (which may vary due to the compressive force applied to the stack) will tend towards a value of 360 degrees. This compressive force and resulting distortion in the master plate will also tend to bring the first and second slave compression faces 6, 8 and the corresponding portions 3, 4 of the master compression face into a parallel relationship, while the planar back surfaces 14 of the first and second slave plates 5, 7 adjacent to the fuel cell plate/electrode assembly remain planar and parallel with the fuel cells in the stack.

As shown in FIG. 4a, the first angle θ_{M} between the two portions 3, 4 of the master compression face 2 is preferably reflex (greater than 180 degrees) and the second angle θ_{S} between the first and second slave compression faces 6, 8 is preferably obtuse (between 90 degrees and 180 degrees). In FIG. 4b, the first angle θ_{M} between the two portions 3, 4 of the master compression face 2 is obtuse (between 90 degrees and 180 degrees) and the second angle θ_{S} between the first and second slave compression faces 6, 8 is reflex (greater than 180 degrees).

The first angle θ_{M} and the second angle θ_{S} are preferably selected such that: the first portion 3 of the master compression face 2 and the first slave compression face 6 are non-parallel prior to application of a load to the end plate assemblies; similarly, the second portion 4 of the master compression face 2 and the second slave compression face 8 are non-parallel prior to application of a load to the end plate assemblies. That is, prior to the application of a load to the end plate assemblies to compress the fuel cell stack, the portions 3, 4 of the master compression face 2 and respectively the first and second slave compression faces 6, 8 converge on one another at the centre angled portion of the master compression face 2 (where the two portions 3, 4 of the master compression face 2 meet). However, under the application of the load to maintain the fuel cells under compression, a bending moment in the master plate 1 causes: the first portion 3 of the master compression face 2 and the first slave compression face 6; and the second portion 4 of the master compression face 2 and the second slave compression face 8, to come into parallel relationship with one another by distortion of the master plate 1.

FIG. 4a illustrates the case where the first angle θ_{M} is greater than 180 degrees such that master compression face 2 defines a convex surface, the convex surface being configured such that under the application of the load to maintain the fuel cells under compression, the bending moment in the master plate 1 causes the first portion 3 of the master compression face and the first slave compression face 6 to come into parallel relationship with one another by distortion of the master plate 1 and causes the second portion of the master compression face 4 and the second slave compression face 8 to come into parallel relationship with one another by distortion of the master plate 1.

FIG. 4b illustrates the case where the second angle θ_{S} is greater than 180 degrees such that the first and second slave compression faces 6, 8 together define a convex surface, the convex surface being configured such that under the application of the load to maintain the fuel cells under compression, the bending moment in the master plate 1 causes the first portion of the master compression face 3 and the first slave compression face 6 to come into parallel relationship with one another by distortion of the master plate 1, and causes the second portion of the master compression face 4 and the second slave compression face 8 to come into parallel relationship with one another by distortion of the master plate 1.

The angles θ_{M} and θ_{S} may be selected to suit any particular design of master plate and slave plate, taking into account many different factors such as the degree of stiffness of the master plate, the volume of material required in the slave plates for the required fluid porting and fluid delivery conduits, the desired mass and/or volume of the end plate assembly and the type of materials used.

In another exemplary configuration to those shown in FIGS. 4a and 4b each of the first portion 3 and second portion 4 of the master compression face 2 need not be planar but could be curved surfaces. For example, each of the first portion 3 and second portion 4 could present a convex surface respectively towards the first and second slave compression faces 6, 8. The surfaces 3, 4 may be concave rather than convex. In other examples, the first and second slave compression faces 6, 8 may also, or alternatively, present concave (or convex) surfaces towards the respective portions of the master compression face 2. In a further example, the first and second slave compression faces 6, 8 may be contiguous by abutting the first and second slave plates 5, 7 together along one edge. The master compression face 2 may also be a planar surface in some examples.

The transition between the first portion 3 and second portion 4 of the master compression face 2 need not necessarily be a sharp angle as shown in FIGS. 4a and 4b. The transition can be a smooth rounded transition portion between the two portions 3, 4. For example, a rounded transition portion in the master compression face 2 may follow a cylindrical profile with the flat first and second portions 3, 4 at tangents to the radius of the cylindrical transition portion. The first and second portions 3, 4 of the master compression face 2 can both form part of a continuous convex (or in other examples, concave) surface.

Similarly, the transition between the first and second slave compression faces 6, 8 need not necessarily be a sharp angle as shown in FIGS. 4a and 4b. The transition can be a smooth rounded transition portion between the two faces 6, 8. Thus, the first and second slave compression faces 6, 8 can together provide contiguous concave (or in other examples, convex) surfaces by abutting the first and second slave plates 5, 7 against one another along one edge.

If the master plate 1 has a more complex shaped master compression face 2, this may lead to greater accuracy in the master compression face 2 and the first and second slave compression faces 6, 8 being in parallel relationship with one another under stack compression than having only planar master and slave compression faces. Such a form of master compression face 2 having a rounded transition between the two master compression face portions 3, 4 may be able to accommodate the distortion in the master plate 1 more accurately during compression of the stack, thus resulting in flat compression faces 3, 4 being offered to the corresponding slave plate compression faces 6, 8 in operation.

Further, having first and second slave compression faces 6, 8 forming contiguous surfaces having, for example, a rounded transition between the first and second compression faces 6, 8 (e.g. a swept contour profile of the first and second slave plates together) may be used to better match the distorted face of the master plate 1 under compression.

Other possible profiles of the master compression face, and of the slave compression face (formed by the first and second slave compression faces 6, 8 together when the first and second slave plates 5, 7 are abutted along one edge) include one single curved profile (where the curve may be, for example, spherical, parabolic, or another shape suitable for achieving uniform pressure distribution to the fuel cell stack upon compression of the stack) or the master compression face 2 being substantially flat and facing a curved slave compression face formed from the first and second slave compression faces 6, 8.

The swept form/inclusion of rounded or curved portions in the master compression face 2 and/or the first and second slave compression faces 6, 8 may be achieved by performing, bending, casting or an extrusion, according, for example, to cost requirements.

Other features may be included in the master and slave plates, such as a mechanism or structure by which the slave plates can be registered with the master plate. An exemplary arrangement is shown in FIGS. 1 to 3c in which a tenon 23 or projection or series of projections is formed on the master plate 1 which engages with/into a mortise 24 or corresponding recess or groove in a surface of the slave plate 5, 7. It will be understood that the mortise and tenon structures can be reversed between the master and slave plates.

FIG. 5 shows a flow diagram of a method suitable for forming a fuel cell stack assembly including the steps of: forming a plurality of fuel cells in a stack, the stack defining two opposing parallel end faces (step 51); positioning first and second slave plates of an end plate assembly at one end face of the stack, the first and second slave plates each having respective first and second slave compression faces facing outwardly from the stack (step 52); positioning a master plate defining a master compression face at the end face of the stack such that the master compression face is proximal the first and second slave compression faces (step 53); positioning a second end plate assembly at the opposing end face of the stack (step 54); and coupling the end plate assemblies together to bring the first and second slave compression faces into compressive relationship with the master compression face and to maintain the stack under compression (step 55), and is self-explanatory.

Other embodiments are intentionally within the scope of the accompanying claims.

1. A fuel cell stack assembly comprising:
a plurality of fuel cells in a stack, the stack defining two opposing parallel end faces;
an end plate assembly at each opposing end face of the stack, the end plate assemblies being coupled together to thereby maintain the fuel cells in the stack under compression;
wherein at least one of the end plate assemblies comprises:
a master plate defining a master compression face having a first portion and a second portion;
a first slave plate defining a first slave compression face;
a second slave plate defining a second slave compression face,
the first slave compression face facing the first portion of the master compression face and when assembled, being in compressive relationship therewith,
the second slave compression face facing the second portion of the master compression face and when assembled, being in compressive relationship therewith.

2. The fuel cell stack assembly of claim 1 in which at least one of the slave plates extends laterally from the master plate on at least one side defining a lateral extension portion, the lateral extension portion comprising at least one fluid distribution port communicating with a fluid distribution gallery passing through or alongside the plurality of fuel cells in the stack.

3. The fuel cell stack assembly of claim 1 in which both the first and second slave plates extend laterally from the master plate on at least one side, each of the first and second slave plates thereby defining a lateral extension portion, and each lateral extension portion comprising at least one fluid distribution port communicating with a fluid distribution gallery passing through or alongside the plurality of fuel cells in the stack.

4. The fuel cell stack assembly of claim 2 in which the at least one fluid distribution port includes at least one of a fuel distribution port, a water distribution port, an oxidant distribution port and a coolant fluid distribution port.

5. The fuel cell stack assembly of claim 3 in which the first and second slave plates respectively include a different configuration of fluid distribution port.

6. The fuel cell stack assembly of claim 3 in which
the first slave plate defines at least one of a fuel distribution port and a water distribution port, as the at least one fluid distribution port and;
the second slave plate defines at least one of an oxidant distribution port and a coolant fluid distribution port, as the at least one fluid distribution port.

7. The fuel cell stack assembly of claim 1 in which:
the first and second portions of the master compression face are at a first angle relative to one another; and
the first and second slave compression faces are at a second angle to one another.

8. The fuel cell stack assembly of claim 7 in which the first angle is reflex and the second angle is obtuse, or the first angle is obtuse and the second angle is reflex.

9. The fuel cell stack assembly of claim 7 in which the first angle and the second angle are selected such that the first portion and second portion of the master compression face and respectively the first and second slave compression faces are non-parallel prior to application of a load to the end plate assemblies whereas, under the application of the load to maintain the fuel cells under compression, a bending moment in the master plate causes the first portion of the master compression face and the first slave compression face to come into parallel relationship with one another by distortion of the master plate, and cause the second portion of the master compression face and the second slave compression face to come into parallel relationship with one another by distortion of the master plate.

10. The fuel cell stack assembly of claim 8 in which the first angle is greater than 180 degrees such that master compression face defines a convex surface, the convex surface being configured such that under the application of the load to maintain the fuel cells under compression, the bending moment in the master plate causes the first portion of the master compression face and the first slave compression face to come into parallel relationship with one another by distortion of the master plate, and causes the second portion of the master compression face and the second slave compression face to come into parallel relationship with one another by distortion of the master plate.

11. The fuel cell stack assembly of claim 8 in which the second angle is greater than 180 degrees such that the first and second slave compression faces together define a convex surface, the convex surface being configured such that under the application of the load to maintain the fuel cells under compression, the bending moment in the master plate causes the first portion of the master compression face and the first slave compression face, and the second portion of the master compression face and the second slave compression face, to come into parallel relationship with one another by distortion of the master plate.

12. The fuel cell stack assembly of claim 1 in which the first and second portions of the master compression face both form part of a continuous convex surface and the first and second slave compression faces are contiguous so as to form a concave surface by abutting the first and second slave plates against one another along one edge.

13. The fuel cell stack assembly of claim 1 in which the master plate is formed from metallic material and the slave plates are formed from non-metal material.

14. The fuel cell stack assembly of claim 1 in which both of the end plate assemblies comprise a master plate and a first and second slave plate as defined in claim 1.

15. The fuel cell stack assembly of claim 3 in which a plurality of tie bars are arranged to pass through the lateral extension portions of the first and second slave plates at opposing ends of the fuel cell stack, the tie bars configured to couple the end plate assemblies together to thereby maintain the fuel cells in the stack under compression.

16. The fuel cell stack assembly of claim 15 in which the plurality of tie bars are located inwards of the at least one fluid distribution port proximal the plurality of fuel cells in order to maintain the fuel cell stack under compression.

17. A method of forming a fuel cell stack assembly comprising:
forming a plurality of fuel cells in a stack, the stack defining two opposing parallel end faces;
positioning first and second slave plates of an end plate assembly at one end face of the stack, the first and second slave plates each having respective first and second slave compression faces facing outwardly from the stack;
positioning a master plate defining a master compression face at the end face of the stack such that the master compression face is proximal the first and second slave compression faces;
positioning a second end plate assembly at the opposing end face of the stack; and
coupling the end plate assemblies together to bring the first and second slave compression faces into compressive relationship with the master compression face and to maintain the stack under compression.

18. The fuel cell stack assembly of claim 3 in which the at least one fluid distribution port includes at least one of a fuel distribution port, a water distribution port, an oxidant distribution port and a coolant fluid distribution port.
